(19) United States
(12) Patent Application Publication
(10) Pub. No.: US 2024/0359977 A1
(43) Pub. Date: Oct. 31, 2024

(54) PROCESS TO CONVERT NATURAL GAS AND CARBON DIOXIDE INTO HYDROGEN AND CARBON MONOXIDE

(71) Applicant: Qatar Foundation for Education, Science and Community Development, Doha (QA)

(72) Inventors: Ma'moun Al-Rawashdeh, Doha (QA); Patrick Linke, Doha (QA); Ahmed Mohamed Shehata Soliman, Doha (QA)

(21) Appl. No.: 18/645,872

(22) Filed: Apr. 25, 2024

Related U.S. Application Data
(60) Provisional application No. 63/462,848, filed on Apr. 28, 2023.

(51) Int. Cl. C01B 3/38; C01B 32/40

(52) U.S. Cl. CPC C01B 3/38; C01B 32/40; C01B 2203/0238; C01B 2203/1241

(57) ABSTRACT

A process is provided that can convert the available CO₂ stream (from any captured source) and CH₄ (or natural gas, or hydrocarbon gas) stream to separated streams of CO and H₂. Multiple options exist for utilization. Synthesis gas can be integrated with an existing syngas facility or combined with H₂ from an electrolyze to make methanol or FT synthesis to make liquid fuels. When operating the process with separated H₂ and CO streams. These can be integrated into different chemical processes and not necessarily mixed together. For example, H₂ can be sold as a product, and CO can be used as a feedstock to make chemicals. The present disclosure is a desirable add-on to an industrial facility to process CO₂ emission into the value stream.

### PRIORITY CLAIM AND CROSS-REFERENCE TO RELATED APPLICATIONS

The present application claims the benefit of U.S. Provisional Application No. 63/462,848 filed Apr. 28, 2023, which is incorporated herein by reference in its entirety.

### FIELD

The present disclosure relates generally to a process and method to convert natural gas and carbon dioxide into hydrogen and carbon monoxide.

### BACKGROUND

There are multiple commercial and mature technologies to convert natural gas into synthesis gas (hydrogen and carbon monoxide/carbon monoxide). These are Steam-Methane Reforming (SMR), Partial Oxidation of Methane (POX) and Autothermal Reforming (ATR). These technologies have major climate impacts as they produce rather than use carbon dioxide. There is a pressing need to replace these technologies with lower carbon or negative carbon solutions.

The existing synthesis gas producing technologies are the first unit operations required for the production of essential chemicals including ammonia, methanol and liquid fuels. They also provide the hydrogen needed in many refinery operations. They emit significant CO₂ as part of the reaction stoichiometry and the heating requirements associated with the process. For example, industrial natural gas reforming processes emit between 8 to 15 kg CO₂/kg H₂ depending on the used technology and level of integration. Also, the SMR, POX and ATR reforming reactors produce synthesis gas with different ratios of CO/H₂, which limits technology integration with the downstream chemical production process.

Literature work is available on methane decomposition using heterogeneous catalysts. However, most of the literature only addresses the cracking reaction part, and ignore the carbon formed. Alternatively, the literature removes the formed carbon on the catalyst during the cracking (decomposition) phase with oxygen. This is not available option as it produces CO₂. There is limited literature dedicated to the concept idea of cracking and gasification with CO₂ and H₂O. However, that literature is mainly limited to finding a catalyst that can do this reaction in a stable manner, and demonstrated its working principle. The longest demonstration of this reaction was shown for a couple of hours, to a day, operation. To date, there is no process-level concept on this technology option and how to operate the reactor and separate the products.

A technology option to consider is the dry reforming of methane. In this option, CO₂ and CH₄ are co-fed together into a reactor to make a synthesis gas. The main challenge of this technology is catalyst stability as carbon formation is thermodynamically more favored at the reaction conditions. Some efforts have been conducted to add some water or oxygen to influence reaction conditions.

Moreover, there is a growing interest and technology development area to split methane into carbon and hydrogen. There are many technology options that address this challenge using thermal plasma, molten metals, resistive heating catalysts, and two step catalytic approaches. However, in all of these technology options, the main products are separated streams of CO and H₂, and not carbon. The other relevant topic is coal gasification with CO₂, O₂, and H₂O. This is a wide field with many technology options. All are dedicated to converting the coal into synthesis gas. These technology options do not use natural gas, methane or hydrocarbon gas as the feedstock.

Therefore, there is a need for a path to eliminate this CO₂ footprint and generate carbon credits in addition. There is also a need for the generation of wide ranges of CO/H₂ ranges that can work for a wide variety of downstream process.

### SUMMARY

Example systems, methods, and apparatus are disclosed herein for a process to convert natural gas and carbon dioxide into hydrogen and carbon monoxide.

In light of the disclosure herein, and without limiting the scope of the invention in any way, in a first aspect of the present disclosure, a cyclic catalytic system including at least one reactor zone, a first feed and a second feed. Where each of the at least one reactor has a first and a second mode of operation.

In a second aspect of the present disclosure, which may be combined with any other aspect listed herein unless specified otherwise, each of the first feed and second feed correspond with the first mode of operation and the second mode of operation.

In a third aspect of the present disclosure, which may be combined with any other aspect listed herein unless specified otherwise, the first feed is comprised of one of methane or a methane-rich stream.

In a fourth aspect of the present disclosure, which may be combined with any other aspect listed herein unless specified otherwise, the second feed is comprised of one of carbon dioxide or a carbon dioxide-rich stream.

In a fifth aspect of the present disclosure, which may be combined with any other aspect listed herein unless specified otherwise, first mode of operation is a cracking mode, and in the cracking mode, the at least one reactor receives the first feed.

In a sixth aspect of the present disclosure, which may be combined with any other aspect listed herein unless specified otherwise, the first feed is converted over a solid catalyst into hydrogen and solid carbon, and the solid carbon is deposited on the solid catalyst.

In a seventh aspect of the present disclosure, which may be combined with any other aspect listed herein unless specified otherwise, the at least one reactor zone further includes an exit stream during the cracking mode, and the exit stream includes hydrogen and unreacted first feed.

In an eight aspect of the present disclosure, which may be combined with any other aspect listed herein unless specified otherwise, the second mode of operation is a gasification mode, and in the gasification mode, the at least one reactor receives the second feed.

In a ninth aspect of the present disclosure, which may be combined with any other aspect listed herein unless specified otherwise, the second feed reacts with the solid carbon deposited on the solid catalyst and forms one of carbon monoxide, carbon dioxide, or a mixture thereof.

In a tenth aspect of the present disclosure, which may be combined with any other aspect listed herein unless specified otherwise, the at least one reactor zone further includes a second exit stream during the gasification mode, and the second exit stream includes carbon monoxide, carbon dioxide, and unreacted second feed.

In an eleventh aspect of the present disclosure, which may be combined with any other aspect listed herein unless specified otherwise, further including a first and a second storage vessel, the first storage vessel is configured to collect the first exit stream and the second storage vessel is configured to collect the second exit stream.

In a twelfth aspect of the present disclosure, which may be combined with any other aspect listed herein unless specified otherwise, further including a combined storage vessel, the combined storage vessel is configured to collect the first exit stream and the second exit stream.

In a thirteenth aspect of the present disclosure, which may be combined with any other aspect listed herein unless specified otherwise, a method of gas conversion using a cyclic catalytic system including at least one reactor zone, where each of the at least one reactor has a first and a second mode of operation, first feed, and a second feed. The method includes providing inputs that are at least one of hydrocarbon gas and carbon dioxide and providing outputs that are at least one of hydrogen and carbon monoxide.

In a fourteenth aspect of the present disclosure, which may be combined with any other aspect listed herein unless specified otherwise, the hydrocarbon gas is fed through the first feed.

In a fifteenth aspect of the present disclosure, which may be combined with any other aspect listed herein unless specified otherwise, the carbon dioxide is fed through the second feed.

In a sixteenth aspect of the present disclosure, any of the structure, functionality, and alternatives disclosed in connection with any one or more of FIGS. 1 to 5 may be combined with any other structure, functionality, and alternatives disclosed in connection with any other one or more of FIGS. 1 to 5.

In an embodiment, a gas conversion process is provided. The process includes providing inputs that are at least one of hydrocarbon gas and carbon dioxide; and providing outputs that are at least one of hydrogen and carbon monoxide.

In light of the present disclosure and the above aspects, it is therefore an advantage of the present disclosure to provide users with a process and method to a path to eliminate a CO₂ footprint, generate carbon credits, and generate wide ranges of CO/H₂ ranges that can work for a wide variety of downstream process.

Additional features and advantages are described in, and will be apparent from, the following Detailed Description and the Figures. The features and advantages described herein are not all-inclusive and, in particular, many additional features and advantages will be apparent to one of ordinary skill in the art in view of the figures and description. In addition, any particular embodiment does not have to have all of the advantages listed herein and it is expressly contemplated to claim individual advantageous embodiments separately. Moreover, it should be noted that the language used in the specification has been selected principally for readability and instructional purposes, and not to limit the scope of the inventive subject matter.

### BRIEF DESCRIPTION OF THE FIGURES

The patent or application file contains at least one drawing executed in color. Copies of this patent or patent application publication with color drawing(s) will be provided by the Office upon request and payment of the necessary fee.

FIG. 1 shows a reactor design with a single reactor zone, according to an example embodiment of the present disclosure.

FIG. 2 shows an alternative reactor design with multiple reactor zones, according to an example embodiment of the present disclosure.

FIG. 3 shows an alternative reactor design with multiple reactor zones each connected to multiple feeds, according to an example embodiment of the present disclosure.

FIG. 4 shows an alternative reactor design with multiple reactor zone streams mixed, according to an example embodiment of the present disclosure.

FIG. 5 shows a graph of operating times on stream for a reaction, according to an example embodiment of the present disclosure.

### DETAILED DESCRIPTION

Example embodiments will now be described more fully with reference to the accompanying drawings.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specific the presence of stated features, integers, steps, operations, elements, and/or components, but do not preclude the presence or additional of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent”). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

Methods, systems, and apparatus are disclosed herein for a process to convert natural gas and carbon dioxide into hydrogen and carbon monoxide.

While the example methods, apparatus, and systems are disclosed herein for a process to convert natural gas and carbon dioxide into hydrogen and carbon monoxide, it should be appreciated that the methods, apparatus, and systems may be operable for other chemical processes.

The present disclosure includes CO₂ negative at the reaction stoichiometry level. CO₂ is used as a feedstock to convert the solid carbon formed at the catalyst into carbon monoxide to make the catalyst available for a new cracking cycle. Also, the cyclic reactors operating modes allow to production of separated streams of H₂ and CO in the gas phase. Separating these products from the unreacted feed gases is significantly less challenging as compared to the separations faced in the existing SMR, ATR and POX processes.

The present disclosure can also directly produce synthesis gas that can be integrated with an existing syngas facility. Synthesis gas is the starting point for the production of many bulk and platform chemicals including methanol, ammonia and urea so that the present disclosure can have a wide range of applications in multi-billion-dollar product markets. The present disclosure can also enable solutions to decarbonize existing facilities by processing CO₂ emissions from these facilities and producing valuable syngas feedstocks.

The present disclosure relates to a cyclic catalytic process including, for example, one or more reactor zones, each with two modes of operation (Mode I and Mode II) and two different feeds (Feed A and Feed B), one per mode of operation. Feed A can be methane, or methane rich stream. Feed B is specified to be carbon dioxide, or carbon dioxide rich stream.

In operating Mode I (cracking), a reactor zone receives Feed A, which is converted over a solid catalyst into two products: hydrogen and solid carbon, the latter of which is deposited on the catalyst. The reactor zone exit stream during operating Mode I contains hydrogen and unreacted Feed A. In operating Mode II (gasification), a reactor zone receives Feed B that reacts with the solid carbon that was deposited on the solid catalyst during operating Mode I to form carbon monoxide, carbon dioxide or a mixture thereof. The reactor zone exit stream during operating Mode II contains carbon monoxide, carbon dioxide and unreacted Feed B.

The implementation of the cyclic process into a reactor design can follow two alternative strategies: periodic feed switching or catalyst circulation. This results in multiple alternative reactor design implementations as described below.

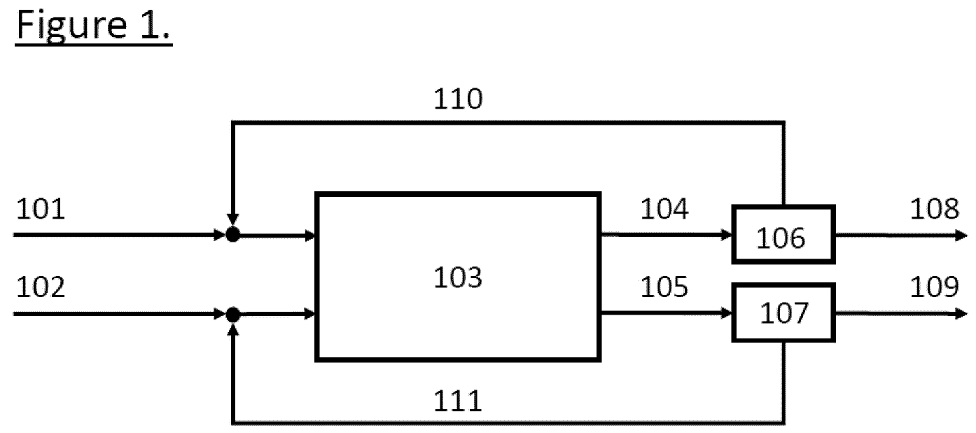

For periodic feed switching, the simplest form of a reactor design contains a single reactor zone that is connected to both Feeds A and B, each with flow controls to enable periodic feeding of either feed to facilitate switching between operating Modes I and II over time. For the single-zone reactor to achieve continuous product flow of constant composition, the reactor exit streams produced during operating Modes I and II are either collected in two separate storage vessels, one to store the hydrogen/hydrocarbon mixture produced in Mode I and one to store the carbon monoxide/carbon dioxide mixture produced in Mode II, or fed in one equipment for combined storage and mixing of exit streams produced in operating Modes I and II. This is demonstrated in FIG. 1.

Specifically, FIG. 1 shows a reactor design with a single reactor zone. As seen in FIG. 1, the reactor design includes, Feed A (operating Mode I) 101, Feed B (operating Mode II) 102, Reactor zone(s) with catalyst (alternating Mode I/II) 103, reactor exit stream (Mode I) 104, reactor exit stream (Mode II) 105, storage (Feed A recovery and purification) 106, storage (Feed B recovery and purification) 107, hydrogen product 108, carbon monoxide product 109, Feed A recycle 110, and Feed B recycle 111.

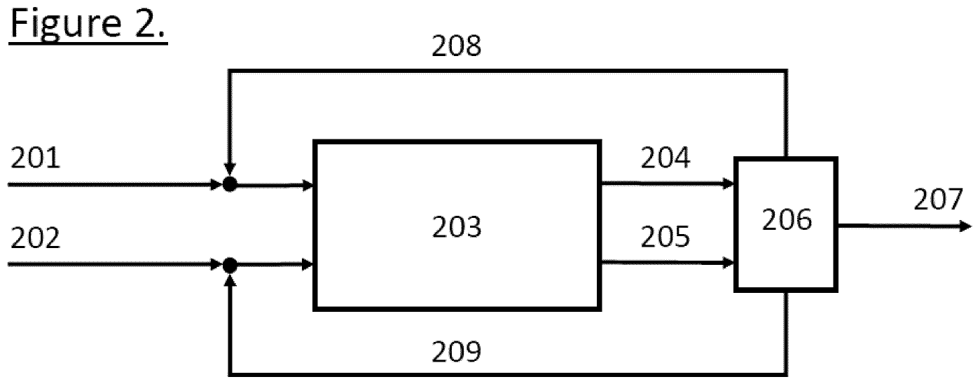

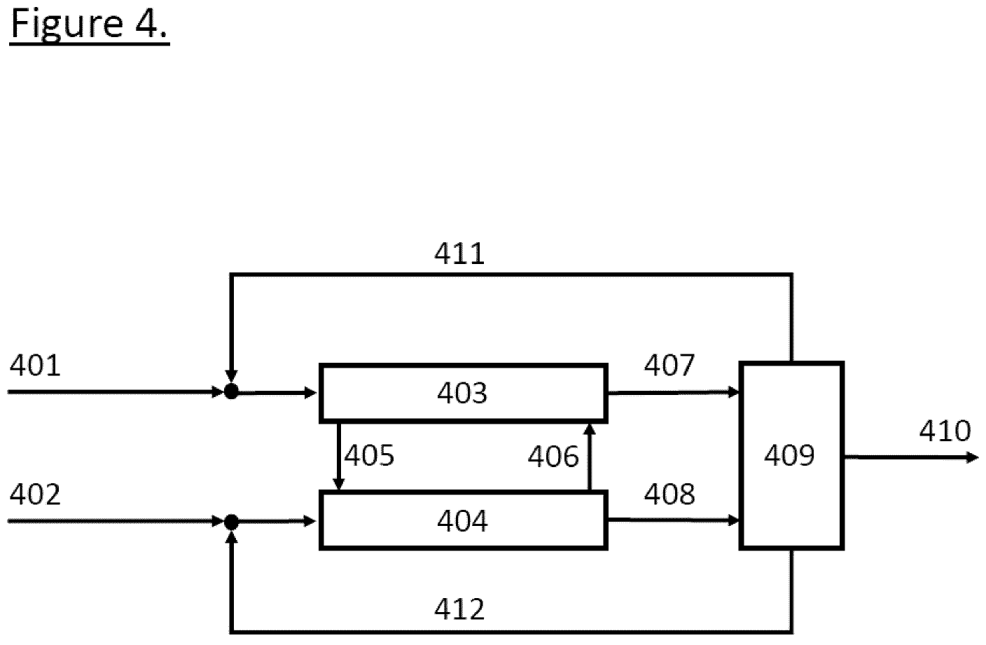

FIG. 2 shows an alternative multi-zone reactor design can achieve continuous product flows of constant composition with no or limited storage/mixing of reactor exit streams. In this design, two or more reactor zones are arranged in a reactor with each zone being connected to both Feeds A and B. As seen in FIG. 2, the alternative multi-zone reactor design includes Feed A (during operating Mode I) 201, Feed B (during operating Mode II) 202, reactor zone(s) with catalyst (alternating Mode I/II) 203, reactor exit stream (Mode I) 204, reactor exit stream (Mode II) 205, storage (Feed A/B recovery and purification) 206, synthesis gas product 207, Feed A recycle 208, and Feed B recycle 209. Each feed to zone connection has flow controls to enable periodic feeding of either feed to facilitate switching between operating Modes I and II in each reactor zone over time. Feeds to the different reactor zones are controlled such that there is always one or more zone operating in Mode I and one or more zone operating in Mode II. The reactor exit streams of all zones are either mixed together (as in FIG. 4), or alternatively fed into two different reactor effluent collection flow lines, one receiving all reactor exit streams of all zones operating in Mode I (hydrogen/hydrocarbon mixture) and the other receiving the reactor exit streams of all zones operating in Mode II (carbon monoxide/carbon dioxide mixture). This option significantly simplifies the process separation steps.

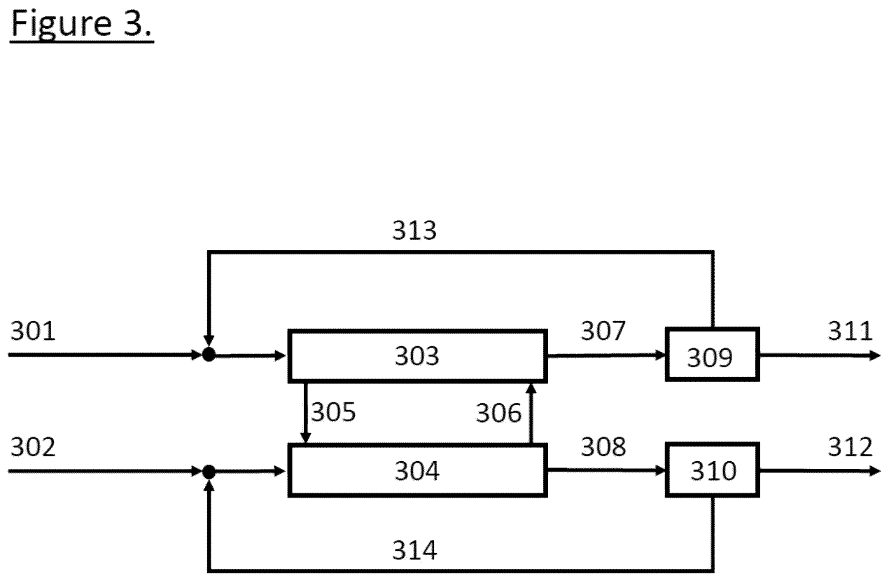

Regarding FIGS. 3 and 4. FIG. 3 shows an alternative reactor design with multiple reactor zones each connected to multiple feeds. As seen in FIG. 3, the reactor includes Feed A 301, Feed B 301, reactor zone(s) in Mode I 303, reactor zone(s) in Mode II 304, catalyst with solid carbon deposit 305, regenerated catalyst 306, reactor exit stream (Mode I) 307, reactor exit stream (Mode II) 308, storage (Feed A recovery and purification) 309, storage (Feed B recovery and purification) 310, hydrogen product 311, carbon monoxide product 312, Feed A recycle 313, and Feed B recycle 314. FIG. 4 shows an alternative reactor design with multiple reactor zone streams mixed. As seen in FIG. 4, the reactor includes Feed A 401, Feed B 402, reactor zone(s) in Mode I 403, reactor zone(s) in Mode II 404, catalyst with solid carbon deposit 406, regenerated catalyst, reactor exit stream (Mode I), reactor exit stream (Mode II) 408, storage (Feed A/B recovery and purification) 409, synthesis gas product 410, Feed A recycle 411, and Feed B recycle 412.

For catalyst circulation, two reactor zones are arranged so that one zone continuously receives Feed A and operates in Mode I, while the other zone continuously receives Feed B and operates in Mode II. The fluidized catalyst is continuously circulated between the two reactor zones. The exit streams of both reactor zones are either mixed together, or alternatively fed into two separate reactor effluent collection flow lines as in the periodic feeding design above.

A process implementing any of the reactor designs can have two main variants when it comes to products. Either the process produces the mixed product collected from the two operating modes, or products collected in two separate reactor effluent collection flow lines can be separated into hydrogen and carbon monoxide products. Hydrogen is separated from hydrocarbon mixtures using pressure swing adsorption, or alternative available technologies for hydrogen separations from gas streams. Carbon dioxide is separated from carbon monoxide using chemical absorption or alternative available technologies for carbon dioxide separations. Alternatively, carbon monoxide is separated from carbon dioxide using pressure swing adsorption or alternative available technologies for carbon monoxide separations. Unreacted Feed A and Feed B recovered in the product separations are recycled back to reactor zones operating in Modes I and II, respectively.

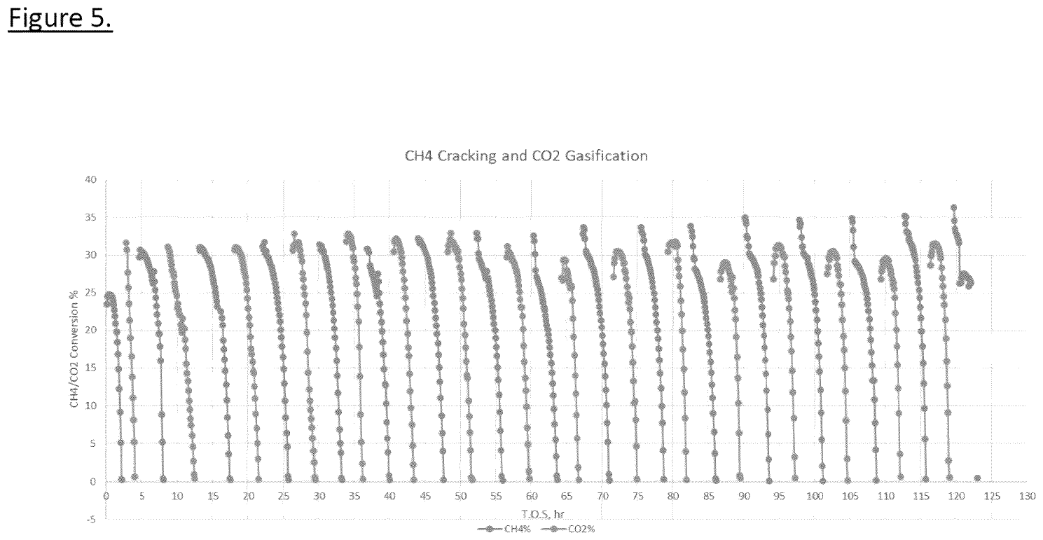

Different catalysts have been evaluated for use with the aforementioned reactor designs. FIG. 5 shows a graph of operating times on stream for a reaction, according to an example embodiment of the present disclosure. As seen in FIG. 5, the graph demonstrates one of the longest operating times on stream for this reaction.

The present disclosure provides a solution for a pressing challenge faced by multiple industries in light of the ongoing energy transition and decarbonization. It enables the utilization of carbon dioxide to produce value-added products as well as the production of carbon-negative hydrogen. Moreover, the process offers advantages over alternative technologies in that fewer product separations are required, resulting in reduced processing costs.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

The invention is claimed as follows:

1. A cyclic catalytic system comprising:
at least one reactor zone, wherein each of the at least one reactor has a first and a second mode of operation;
a first feed; and
a second feed.

2. The system of claim 1, wherein each of the first feed and second feed correspond with the first mode of operation and the second mode of operation.

3. The system of claim 1, wherein the first feed is comprised of one of methane or a methane-rich stream.

4. The system of claim 1, wherein the second feed is comprised of one of carbon dioxide or a carbon dioxide-rich stream.

5. The system of claim 1, wherein the first mode of operation is a cracking mode, and wherein in the cracking mode, the at least one reactor receives the first feed.

6. The system of claim 5, wherein the first feed is converted over a solid catalyst into hydrogen and solid carbon, and wherein the solid carbon is deposited on the solid catalyst.

7. The system of claim 6, wherein the at least one reactor zone further comprises an exit stream during the cracking mode, and wherein the exit stream comprises hydrogen and unreacted first feed.

8. The system of claim 6, wherein the second mode of operation is a gasification mode, and wherein in the gasification mode, the at least one reactor receives the second feed.

9. The system of claim 8, wherein the second feed reacts with the solid carbon deposited on the solid catalyst and forms one of carbon monoxide, carbon dioxide, or a mixture thereof.

10. The system of claim 9, wherein the at least one reactor zone further comprises a second exit stream during the gasification mode, and wherein the second exit stream comprises carbon monoxide, carbon dioxide, and unreacted second feed.

11. The system of claim 10, further comprising a first and a second storage vessel, wherein the first storage vessel is configured to collect the first exit stream and the second storage vessel is configured to collect the second exit stream.

12. The system of claim 10, further comprising a combined storage vessel, wherein the combined storage vessel is configured to collect the first exit stream and the second exit stream.

13. A method of gas conversion using a cyclic catalytic system comprising at least one reactor zone, wherein each of the at least one reactor has a first and a second mode of operation, a first feed, and a second feed, the method comprising:
providing inputs that are at least one of hydrocarbon gas and carbon dioxide; and
providing outputs that are at least one of hydrogen and carbon monoxide.

14. The method of claim 13, wherein the hydrocarbon gas is fed through the first feed.

15. The method of claim 13, wherein the carbon dioxide is fed through the second feed.
